(19) United States
(12) Patent Application Publication
(10) Pub. No.: US 2016/0291411 A1
(43) Pub. Date: Oct. 6, 2016

(54) LIQUID CRYSTAL DISPLAY AND MANUFACTURING METHOD THEREOF

(71) Applicant: Samsung Display Co., Ltd, Yongin-si (KR)

(72) Inventors: Kwang Soo BAE, Suwon-si (KR); Jung Suk BANG, Seoul (KR); Min Jeong OH, Incheon (KR); Hae Ju YUN, Hwaseong-si (KR)

(21) Appl. No.: 15/059,132

(22) Filed: Mar. 2, 2016

(30) Foreign Application Priority Data
Mar. 31, 2015 (KR) 10-2015-0045222

(51) Int. Cl. G02F 1/1337; G02F 1/1341; G02F 1/1333; G02F 1/1368; G02F 1/1343

(52) U.S. Cl. CPC G02F 1/133711; G02F 1/1368; G02F 1/13439; G02F 1/134363; G02F 1/133377; G02F 1/1341; G02F 1/133788

(57) ABSTRACT

The present invention relates to a liquid crystal display and a manufacturing method thereof. An exemplary embodiment of the present invention provides a manufacturing method of a liquid crystal display, comprising: forming a thin film transistor on a substrate; forming a passivation layer on the thin film transistor; forming a first electrode and a second electrode generating a horizontal electric field on the passivation layer; forming a sacrificial layer on the second electrode; forming a roof layer on the sacrificial layer; forming a plurality of microcavities in which a liquid crystal injection hole is formed by removing the sacrificial layer; injecting a photo-alignment material into the microcavity; irradiating the photo-alignment material with polarized light of a first wavelength and polarized light of a second wavelength; baking the photo-alignment material; and injecting a liquid crystal material into the plurality of microcavities.

### CROSS-REFERENCE TO RELATED APPLICATION

This application claims priority to and the benefit of Korean Patent Application No. 10-2015-0045222 filed in the Korean Intellectual Property Office on Mar. 31, 2015, the entire contents of which are incorporated by reference herein.

### BACKGROUND

(a) Field of the Invention

The present invention relates to a liquid crystal display and a manufacturing method thereof.

(b) Description of the Related Art

One of the most widely used flat panel displays, a liquid crystal display, includes two display panels on which field generating electrodes such as a pixel electrode and a common electrode are formed, and a liquid crystal layer interposed between the two display panels.

The liquid crystal display generates an electric field in the liquid crystal layer by applying a voltage to the field generating electrodes to determine orientations of liquid crystal molecules of the liquid crystal layer and control polarization of incident light, thereby displaying an image.

A technology for forming a cavity in the unit of a pixel and filling the cavity with liquid crystal to implement a display has been developed as one of the liquid crystal displays. This technology is one of manufacturing a display by forming a sacrificial layer with an organic material and the like, forming a supporting member on the sacrificial layer, removing the sacrificial layer, and filling an empty space formed through the removal of the sacrificial layer with liquid crystal through a liquid crystal injection hole, instead of forming an upper panel on a lower panel.

According to the above-described display technology, since it is extremely difficult to rub the inside of the cavity in which the liquid crystal is filled, a photoalignment method wherein anisotropy is induced in a polymer film by light irradiation, which is used for aligning a liquid crystal, has been recently researched. Particularly, with regard to methods for aligning the liquid crystal through the photoalignment method, research for improving afterimage characteristic (i.e., reducing afterimages) has been constantly performed.

The above information disclosed in this Background section is only for enhancement of understanding of the background of the invention and therefore it may contain information that does not form the prior art that is already known in this country to a person of ordinary skill in the art.

### SUMMARY

The present invention has been made to provide a liquid crystal display, and a manufacturing method thereof, that includes an alignment layer that improves afterimage characteristics of the display.

An exemplary embodiment of the present invention provides a manufacturing method for making a liquid crystal display, the method comprising: forming a thin film transistor on a substrate; forming a passivation layer on the thin film transistor; forming a first electrode and a second electrode generating a horizontal electric field on the passivation layer; forming a sacrificial layer on the second electrode; forming a roof layer on the sacrificial layer; forming a plurality of microcavities in which a liquid crystal injection hole is formed by removing the sacrificial layer; injecting a photo-alignment material into the microcavity; irradiating the photo-alignment material with polarized light of a first wavelength and polarized light of a second wavelength; baking the photo-alignment material; and injecting a liquid crystal material into the plurality of microcavities.

The photo-alignment material may comprise a photo-isomer material.

Irradiating the photo-alignment material with the polarized light of the first wavelength may change an alignment direction of the photo-alignment material.

The photo-alignment material may comprise azo benzene.

The first wavelength may be about 330 nanometers to about 380 nanometers.

The first wavelength may be about 365 nanometers.

The polarized light of the first wavelength may have energy of about 4 joules to about 6 joules.

The photo-alignment material may be decomposed in the irradiating of the polarized light of the second wavelength.

The photo-alignment material may comprise azo benzene.

The second wavelength may be about 230 nanometers to about 270 nanometers.

The second wavelength may be about 254 nanometers.

The polarized light of the second wavelength may have energy of about 4 joules to about 6 joules.

The irradiation with the polarized light may first comprise irradiating the photo-alignment material with the polarized light of the first wavelength and then may comprise irradiating the photo-alignment material with the polarized light of the second wavelength.

The irradiation with the polarized light may comprise simultaneously irradiating the photo-alignment material with the polarized light of the first wavelength and the polarized light of the second wavelength.

Another embodiment of the present invention provides a liquid crystal display comprising: a substrate; a thin film transistor disposed on the substrate; a passivation layer disposed on the thin film transistor; a first electrode and a second electrode disposed on the passivation layer and generating a horizontal electric field together; an alignment layer disposed on the second electrode; and a roof layer facing the second electrode, wherein a plurality of microcavities may be formed between the second electrode and the roof layer, each microcavity may comprise a liquid crystal material, and the alignment layer may comprise a photo-alignment material that is decomposed when irradiated with light of a predetermined wavelength.

The photo-alignment material may comprise a photo-isomer material.

The photo-alignment material may comprise azo benzene.

An alignment direction of the photo-alignment material may be changed by irradiating the photo-alignment material with light having a wavelength of about 330 nanometers to about 380 nanometers, and the photo-alignment material may be decomposed by irradiating the photo-alignment material with light having a wavelength of about 230 nanometers to about 270 nanometers.

An alignment direction of the photo-alignment material may be changed by irradiating the photo-alignment material with light having a wavelength of about 365 nanometers, and the photo-alignment material may be decomposed by irradiating the photo-alignment material with light having a wavelength of about 254 nanometers.

The liquid crystal display may further comprise: a lower insulating layer disposed between the microcavity and the roof layer; an upper insulating layer disposed on the roof layer; and a capping layer disposed on the upper insulating layer.

According to exemplary embodiments of the present invention, it is possible to form an alignment layer with improved alignment force by irradiating a photo-alignment material with light of a predetermined wavelength so that non-aligned photo-alignment material may be decomposed.

### BRIEF DESCRIPTION OF THE DRAWINGS

FIG. 1 is a top plan view of a liquid crystal display according to an exemplary embodiment of the present invention.

FIG. 2 is a cross-sectional view of FIG. 1 taken along line II-II.

FIG. 3 is a cross-sectional view of FIG. 1 taken along line III-III.

FIG. 4 is a flowchart of a method of forming an alignment layer according to an exemplary embodiment of the present invention.

FIGS. 5, 6, 7, 8, 9, 10, 11, 12, 13, 14, and 15 are cross-sectional views for illustrating a manufacturing method of a liquid crystal display according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

A liquid crystal display and a manufacturing method thereof according to an exemplary embodiment of the present invention will now be described in detail with reference to the accompanying drawings.

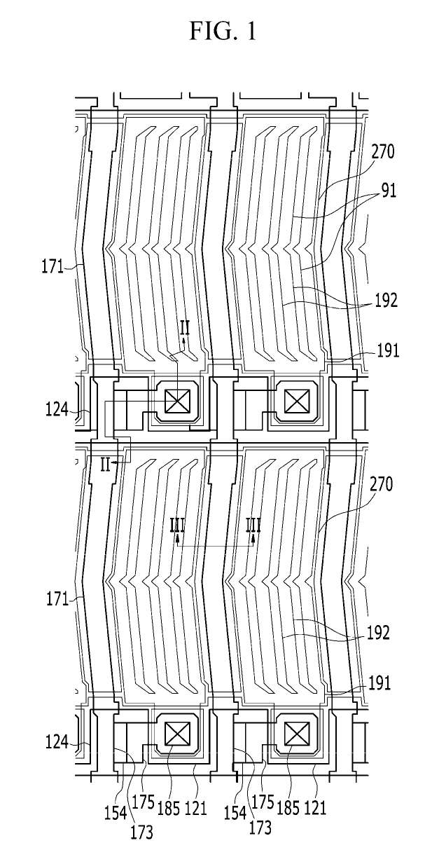

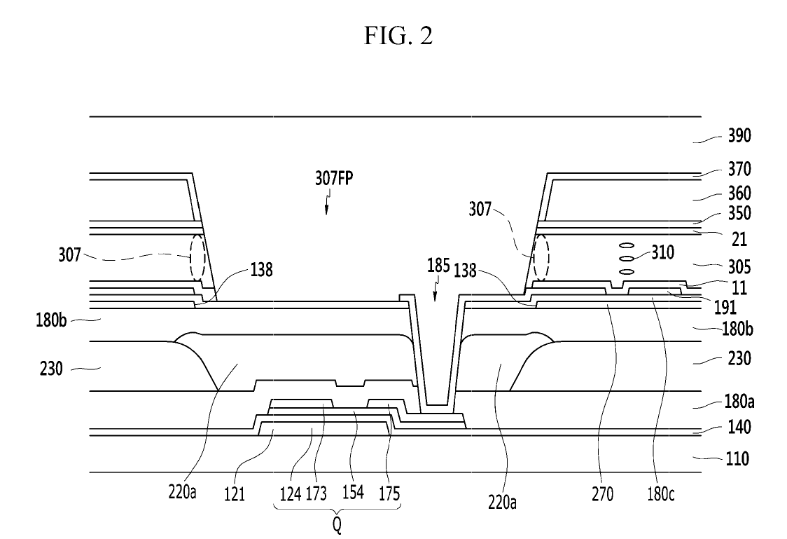

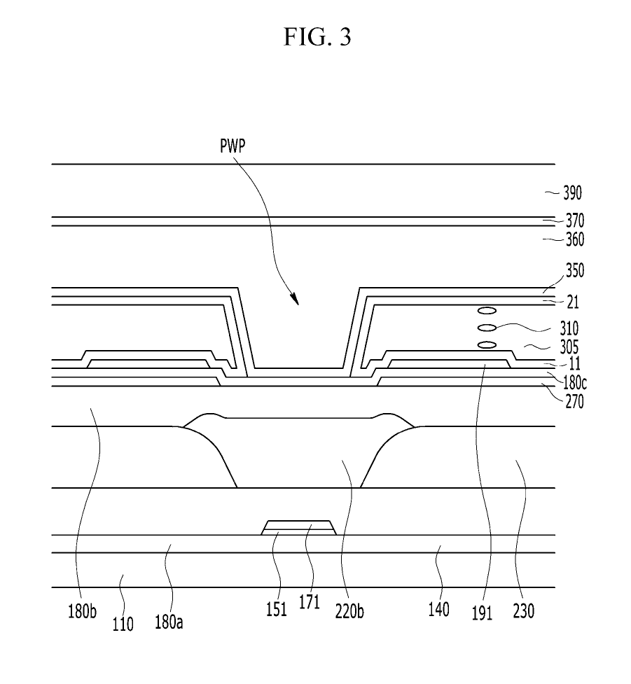

FIG. 1 is a top plan view of a liquid crystal display according to an exemplary embodiment of the present invention. FIG. 2 is a cross-sectional view of FIG. 1 taken along line II-II. FIG. 3 is a cross-sectional view of FIG. 1 taken along line III-III.

Referring to FIGS. 1 to 3, a gate line 121 is formed on a substrate 110 made of transparent glass, plastic, or the like. The gate line 121 includes a gate electrode 124, and a wide end portion (not shown) for connection with another layer or an external driving circuit. The gate line 121 may be made of an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), titanium (Ti), etc. However, the gate line 121 may have a multilayer structure in which at least two conductive layers having different physical properties are included.

A gate insulating layer 140 is formed on the gate conductor 121 that is made of a silicon nitride (SiNₓ) or a silicon oxide (SiOₓ). The gate insulating layer 140 may have a multilayer structure in which at least two insulating layers having different physical properties are included. A semiconductor layer 151 disposed under a data line 171 and a semiconductor layer 154 disposed under source and drain electrodes and in a channel portion of the thin film transistor Q are formed on the gate insulating layer 140. The semiconductor layer 154 may be made of amorphous silicon or polysilicon, or it may be formed of an oxide semiconductor.

A plurality of ohmic contacts may be formed on each of the semiconductor layers 151 and 154, and between the data line 171 and the source and drain electrodes, but these are omitted in the drawings.

Data conductors 171, 173, and 175 including a source electrode 173, the data line 171 connected with the source electrode 173, and a drain electrode 175 are formed on each of the semiconductor layers 151 and 154 and the gate insulating layer 140. The data line 171 includes a wide end portion (not shown) for connection with another layer or an external driving circuit. The data line 171 transmits a data signal, and extends substantially vertically to cross the gate line 121.

The source electrode 173 is a part of the data line 171, and is disposed on the same line as the data line 171. The drain electrode 175 is formed to extend parallel to the source electrode 173. Accordingly, the drain electrode 175 is parallel to the part of the data line 171. The structure of the source electrode 173 and the drain electrode 175 may be modified.

The gate electrode 124, the source electrode 173, and the drain electrode 175 form the thin film transistor Q together with the semiconductor layer 154, and a channel of the thin film transistor Q is formed on the portion of the semiconductor layer 154 between the source electrode 173 and the drain electrode 175.

The data line 171 and the drain electrode 175 may be preferably formed of a refractory metal such as molybdenum, chromium, tantalum, titanium, etc. or an alloy thereof, and may have a multilayer structure in which a refractory metal layer (not shown) and a low resistance conductive layer (not shown) are included. Examples of the multilayer structure may include a double layer of a chromium or molybdenum (or molybdenum alloy) lower layer and an aluminum (alloy) upper layer, and a triple layer of a molybdenum (or molybdenum alloy) lower layer, an aluminum (or an aluminum alloy) middle layer, and a molybdenum (or molybdenum alloy) upper layer.

A first passivation layer 180a is formed on the data conductors 171, 173, and 175 and the exposed semiconductor layer 154. The first passivation layer 180a may comprise an inorganic insulator such as a silicon nitride (SiNx), a silicon oxide (SiOx), or an organic insulator.

A color filter 230 and a light blocking member 220a, 220b are formed on the first passivation layer 180a.

The light blocking member 220a, 220b has a lattice structure having an opening corresponding to an area displaying an image, and is formed of a material preventing light from being transmitted therethrough. The color filter 230 is formed at the opening of the light blocking member 220a, 220b. The light blocking member 220a, 220b includes a horizontal light blocking member 220a formed in a direction parallel to the gate line 121 and a vertical light blocking member 220b formed in a direction parallel to the data line 171.

The color filter 230 may display one of primary colors, such as three primary colors including red, green, and blue. However, the colors are not limited to the three primary colors including red, green, and blue, and the color filter 230 may also display one color among a cyan-based color, a magenta-based color, a yellow-based color, and a white-based color. The color filter 230 may be formed of materials displaying different colors for each adjacent pixel.

A second passivation layer 180b covering the color filter 230 and the light blocking member 220a, 220b is formed on the color filter 230 and the light blocking member 220a, 220b. The second passivation layer 180b may include an inorganic insulating material, such as a silicon nitride (SiNx) and a silicon oxide (SiOx), or an organic insulating material. Contrary to the illustration in the cross-sectional view of FIG. 2, in the case where a step is generated due to a difference in a thickness between the color filter 230 and the light blocking member 220a, 220b, the second passivation layer 180b may comprise an organic insulating material, such that it is possible to decrease or remove the step.

The color filter 230, the light blocking member 220a, 220b, and the passivation layers 180a and 180b have a contact hole 185 exposing the drain electrode 175.

A common electrode 270 is formed on the second passivation layer 180b. The common electrode 270 has a planar shape, and it may be formed to overlap a portion corresponding to one microcavity. Further, the common electrode 270 has an opening 138 disposed in a peripheral area of the drain electrode 175. That is, the common electrode 270 may have a plane shape in the form of a plate.

Common electrodes 270 disposed in adjacent pixels are connected to each other to receive a predetermined level of common voltage transmitted from the outside of a display area.

An interlayer insulating layer 180c is formed on the common electrode 270. The interlayer insulating layer 180c may be formed of the organic insulating material or the inorganic insulating material.

A pixel electrode 191 is disposed on the interlayer insulating layer 180c. The pixel electrode 191 may be formed of a transparent conductive material such as ITO (indium tin oxide) or IZO (indium zinc oxide). The pixel electrode 191 comprises a plurality of cutouts 91 and a plurality of branch electrodes 192 disposed between the adjacent cutouts.

The first passivation layer 180a, the second passivation layer 180b, and the interlayer insulating layer 180c have a contact hole 185 exposing the drain electrode 175. The pixel electrode 191 is physically and electrically connected to the drain electrode 175 through the first contact hole 185 to receive a voltage from the drain electrode 175.

The common electrode 270 is a first field generating electrode or a first electrode, and the pixel electrode 191 is a second field generating electrode or a second electrode. The pixel electrode 191 and the common electrode 270 may form a horizontal electric field. The pixel electrode 191 and the common electrode 270 as field generating electrodes generate an electrical field such that the liquid crystal molecules 310 disposed on the field generating electrodes 191 and 270 are rotated in a direction parallel to the direction of the electric field. As such, according to the determined rotation direction of the liquid crystal molecules, the polarization of light passing through the liquid crystal layer is changed.

According to the liquid crystal display of the shown exemplary embodiment, the common electrode 270 has the planar shape and the pixel electrode 191 has a plurality of branch electrodes, however according to a liquid crystal display of another exemplary embodiment of the present invention, the pixel electrode 191 may have a planar shape and the common electrode 270 may have a plurality of branch electrodes.

The present invention is applied to all cases in which two field generating electrodes overlap with the insulating layer therebetween on the substrate 110, the first field generating electrode under the insulating layer has the plane shape, and the second field generating electrode over the insulating layer has a plurality of branch electrodes.

A lower alignment layer 11 is formed on the pixel electrode 191, and the lower alignment layer 11 comprises a photo-alignment material. The photo-alignment material according to the present exemplary embodiment may be decomposed by irradiating light of a predetermined wavelength thereon. Further, the photo-alignment material according to the present exemplary embodiment may be a photo-isomer material. The photo-alignment material according to the present exemplary embodiment may comprise azo benzene.

An upper alignment layer 21 is disposed to face the lower alignment layer 11, and a microcavity 305 is formed between the lower and upper alignment layers 11 and 21, respectively. A liquid crystal material comprising liquid crystal molecules 310 is injected into the microcavity 305 through an injection hole 307. The injection hole 307 is included in the microcavity 305.

The microcavity 305 may be formed along a column direction of the pixel electrode 191, that is, a vertical direction. In the present exemplary embodiment, the aligning material for forming the alignment layers 11 and 21 and the liquid crystal material comprising the liquid crystal molecules 310 may be injected into the microcavity 305 using capillary force.

The microcavity 305 is divided in a vertical direction by a plurality of injection hole forming areas 307FP disposed at a portion overlapping the gate line 121, and a plurality of microcavities 305 may be formed along the direction in which the gate line 121 is extended. Each of the plurality of formed microcavities 305 may correspond to one or more pixel areas, and the pixel area may correspond to an area displaying an image.

A lower insulating layer 350 is disposed on the upper alignment layer 21. The lower insulating layer 350 may be formed of a silicon nitride (SiNx) or a silicon oxide (SiOx).

A roof layer 360 is disposed on the lower insulating layer 350. The roof layer 360 serves to support the microcavity 305 so that the microcavity 305 may be formed. The roof layer 360 may include a photoresist or other organic materials.

An upper insulating layer 370 is disposed on the roof layer 360. The upper insulating layer 370 may contact an upper surface of the roof layer 360. The upper insulating layer 370 may be formed of a silicon nitride (SiNx) or a silicon oxide (SiOx).

In the present exemplary embodiment, a capping layer 390 fills the liquid crystal injection hole forming area 307FP and covers the liquid crystal injection hole 307 of the microcavity 305 exposed by the liquid crystal injection hole forming area 307FP. The capping layer 390 comprises an organic material or an inorganic material.

In the present exemplary embodiment, as shown in FIG. 3, a partition wall portion PWP is disposed between the microcavities 305 adjacent to each other in a horizontal direction. The partition wall portion PWP may be formed in a direction in which the data line 171 is extended, and it may be covered by the roof layer 360. The partition wall portion (PWP) is filled with the lower and upper insulating layers 350 and 370 and the roof layer 360, which form a partition wall, and thus partitions or defines the microcavity 305. There is a partition wall structure such as the partition wall portion (PWP) between the micro-cavities 305 so when the insulation substrate 110 is bent, less stress is generated and a change of a cell gap is much reduced.

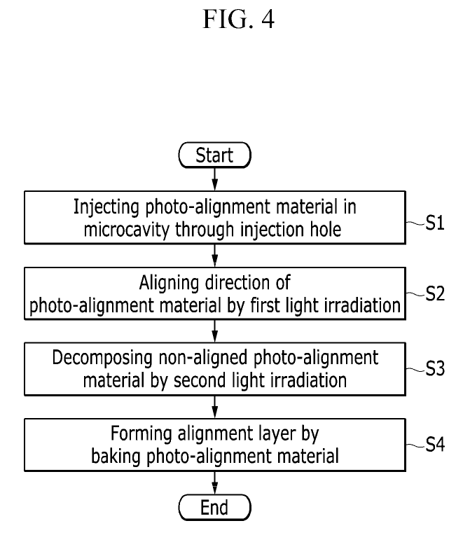

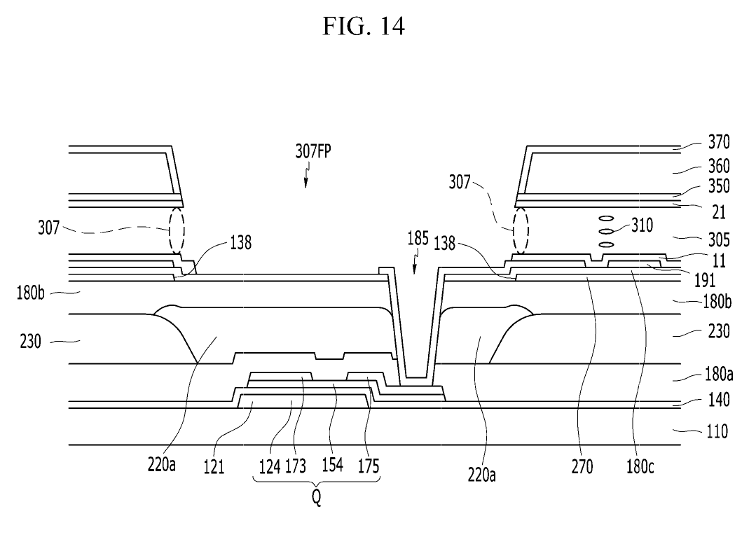

Now, a manufacturing method of an alignment layer and a manufacturing method of a liquid crystal display according to an exemplary embodiment of the present invention will now be described with reference to FIGS. 4 to 15 and the above-described drawings.

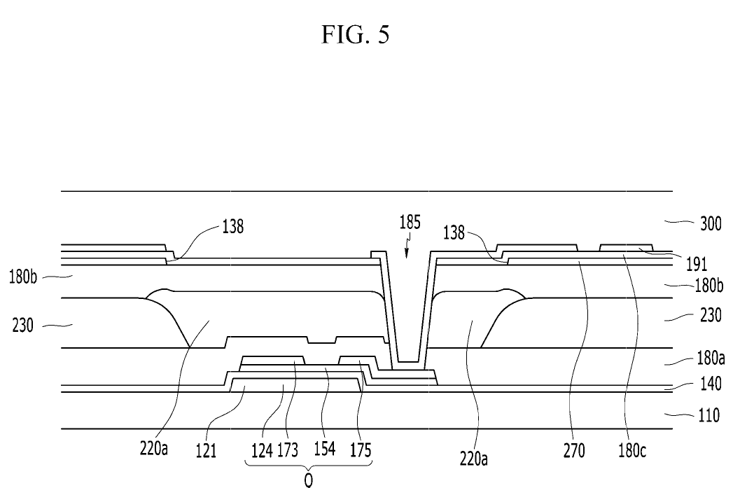

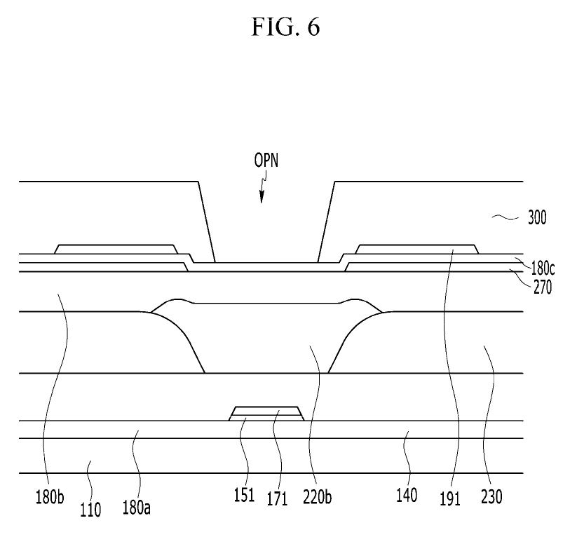

FIG. 4 is a flowchart of a method of forming an alignment layer according to an exemplary embodiment of the present invention, and FIGS. 5 to 15 are cross-sectional views for illustrating a manufacturing method of a liquid crystal display according to an exemplary embodiment of the present invention. FIGS. 5, 7, 9, 11, 12, and 14 sequentially illustrate cross-sectional views of FIG. 1 taken along line II-II. FIGS. 6, 8, 10, 13, and 15 are cross-sectional views of FIG. 1 taken along line III-III.

Hereinafter, an exemplary embodiment of manufacturing the above-described liquid crystal display will be described with reference to FIGS. 4 to 15. An exemplary embodiment which will be described below is an exemplary manufacturing method, which may be variously modified.

Referring to FIGS. 1, 5, and 6, in order to form a generally-known switching element on a substrate 110, a gate line 121 is formed to extend in a horizontal direction, a gate insulating layer 140 is formed on the gate line 121, semiconductor layers 151 and 154 are formed on the gate insulating layer 140, and a source electrode 173 and a drain electrode 175 are formed thereon. In this case, a data line 171 connected to the source electrode 173 may be formed to extend in a vertical direction while crossing the gate line 121.

A first passivation layer 180a is formed on the data conductors 171, 173, and 175 including the source electrode 173, the drain electrode 175, and the data line 171, and an exposed portion of the semiconductor layer 154.

Color filters 230 are formed at a position corresponding to pixel areas on the first passivation layer 180a, and a light blocking member 220a, 220b is formed between the color filters 230.

A second passivation layer 180b is formed on the color filter 230 and the light blocking member 220a, 220b to cover the color filter 230 and the light blocking member 220a, 220b, and the second passivation layer 180b is formed to have the contact hole 185 electrically and physically connecting the pixel electrode 191 and the drain electrode 175.

Next, a common electrode 270 of a planar shape is formed on the second passivation layer 180b. The common electrode 270 has the opening 138 disposed at the portion overlapping the gate line 121 or the data line 171, but may be formed to be connected in the adjacent pixels. An interlayer insulating layer 180c is formed on the common electrode 270, and a pixel electrode 191 is formed on the interlayer insulating layer 180c. The interlayer insulating layer 180c has the contact hole 185 physically and electrically connecting the pixel electrode 191 and the drain electrode 175 along with the first passivation layer 180a and the second passivation layer 180b.

The pixel electrode 191 includes a plurality of cutouts 91 and a plurality of branch electrodes 192 disposed between the adjacent cutouts 91.

Next, a sacrificial layer 300 is formed on the pixel electrode 191. As shown in FIG. 6, an open portion (OPN) is formed in the sacrificial layer 300 along the direction parallel to the data line 171. In a subsequent process, a lower insulating layer 350, a roof layer 360, and an upper insulating layer 370 may be filled in the open portion (OPN) to form a partition wall portion (PWP).

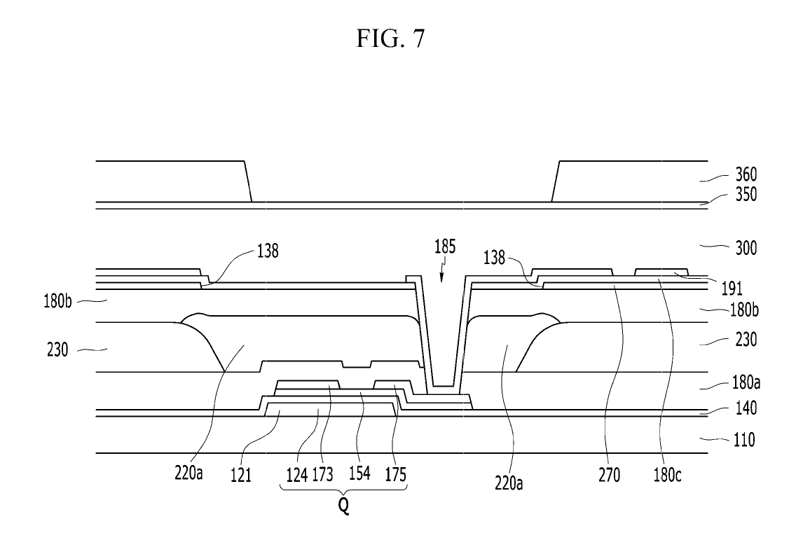

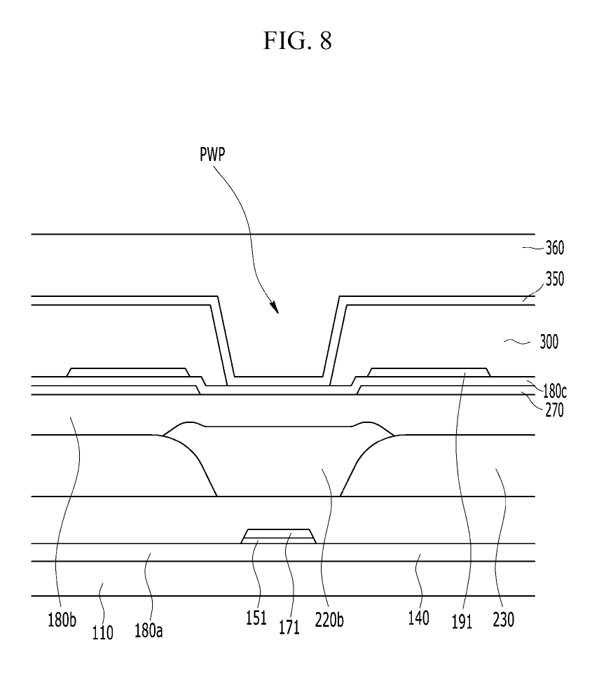

Referring to FIGS. 7 and 8, the lower insulating layer 350 and the roof layer 360 are sequentially formed on the sacrificial layer 300. The roof layer 360 may be removed at the area corresponding to the light blocking member 220a, 220b disposed between the pixel areas adjacent in the vertical direction by an exposure and development process. The roof layer 360 exposes the lower insulating layer 350 in the area corresponding to the light blocking member 220a, 220b. In this case, the lower insulating layer 350 and the roof layer 360 fill the open portion OPN of the vertical light blocking member 220b to form the partition wall portion PWP.

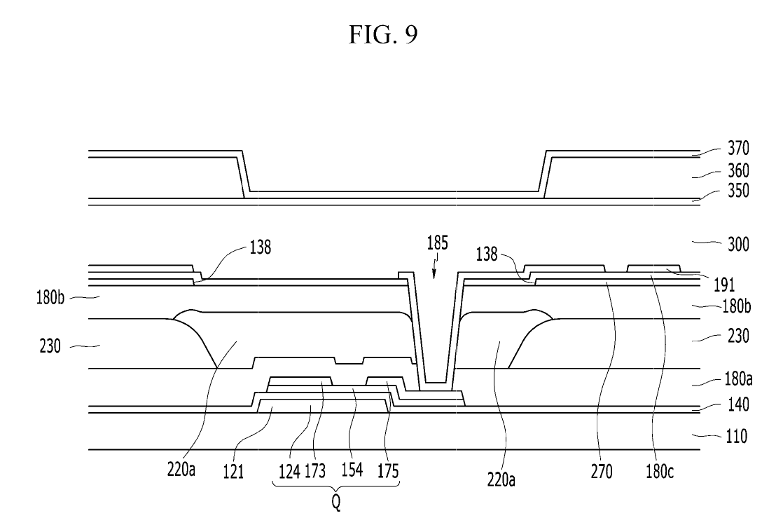

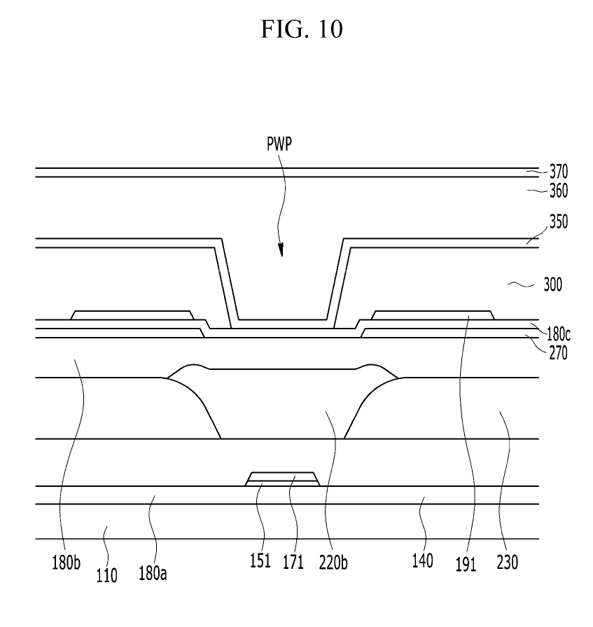

Referring to FIGS. 9 and 10, an upper insulating layer 370 is formed to cover an upper portion of the roof layer 360 and the exposed lower insulating layer 350.

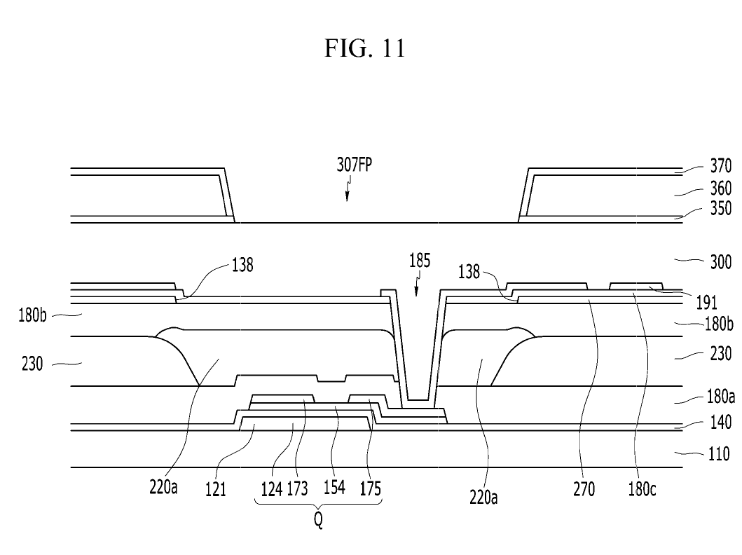

Referring to FIG. 11, the upper insulating layer 370 and the lower insulating layer 350 are dry-etched to partially remove the upper insulating layer 370 and the lower insulating layer 350, thereby forming a liquid crystal injection hole forming area 307FP. In this case, the upper insulating layer 370 may have a structure to cover a lateral surface of the roof layer 360, but it is not limited thereto, and the upper insulating layer 370 covering the lateral surface of the roof layer 360 may be removed to expose the lateral surface of the roof layer 360.

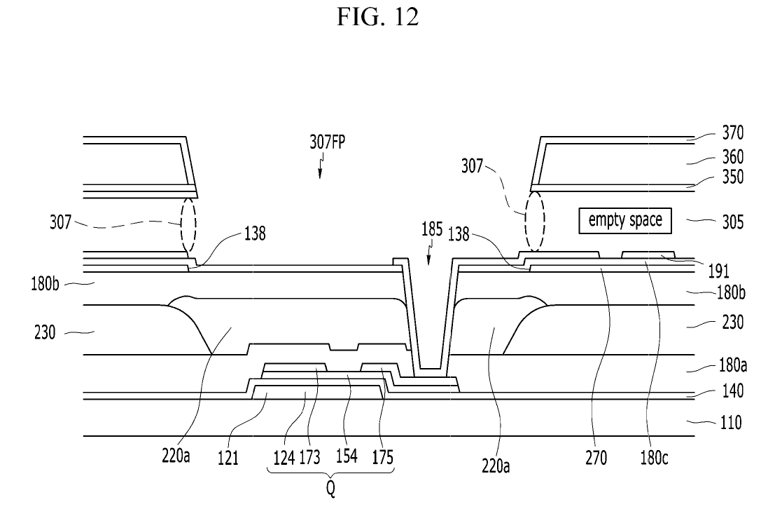

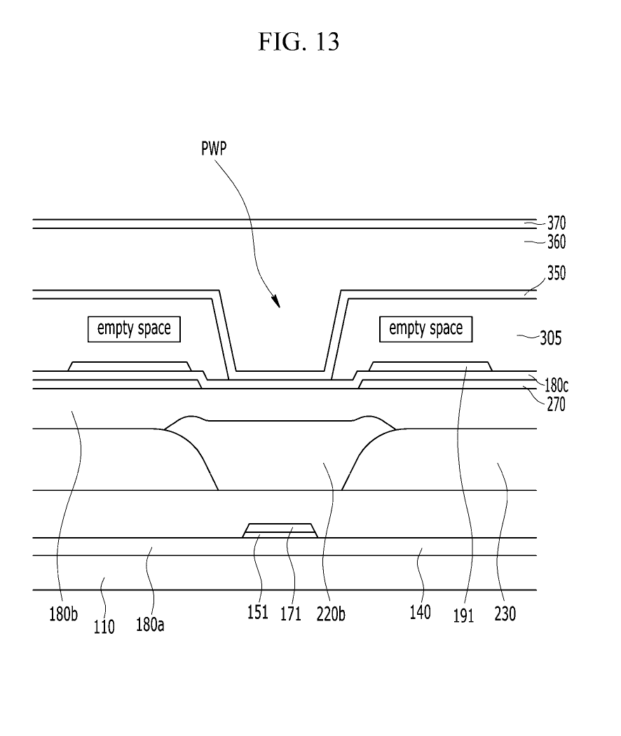

Referring to FIGS. 12 and 13, the sacrificial layer 300 is removed by an oxygen (O₂) ashing process or a wet-etching method through the liquid crystal injection hole forming area 307FP. In this case, a microcavity 305 having the liquid crystal injection hole 307 is formed. The microcavity 305 is an empty space formed when the sacrificial layer 300 is removed.

Referring to FIGS. 4, 13, and 14, a photo-alignment material is injected through the liquid crystal injection hole 307 (51). Herein, the photo-alignment material may be decomposed by irradiating with light of a predetermined wavelength, and the photo-alignment material may comprise a cis-type of photo-isomer or a trans-type of photo-isomer. More specifically, the photo-alignment material may comprise azo benzene.

Next, the photo-alignment material injected into the microcavity 305 is irradiated with polarized ultraviolet rays (UV) of a first wavelength (52). In this case, the first wavelength may be about 330 to about 380 nanometers, and preferably, may be about 365 nanometers. Further, the irradiation energy of the polarized ultraviolet rays of the first wavelength may be about 4 joules to about 6 joules. When the photo-alignment material is irradiated with polarized ultraviolet rays of the first wavelength, most of the photo-alignment material is aligned in a 90° direction with respect to the polarized direction. However, a portion of the photo-alignment material is aligned in directions other than in the 90° direction with respect to the polarized direction.

Next, the photo-alignment material injected into the microcavity 305 is irradiated with polarized ultraviolet rays (UV) of a second wavelength (S3). In this case, the second wavelength may be about 230 to about 270 nanometers, and preferably, may be about 254 nanometers. Further, the irradiation energy of the polarized ultraviolet rays of the second wavelength may be about 4 joules to about 6 joules. When the photo-alignment material is irradiated with polarized ultraviolet rays of the second wavelength, the photo-alignment material not aligned by the irradiation of the polarized ultraviolet rays of the first wavelength is decomposed.

Thus, improvement of alignment characteristics may be introduced in a predetermined direction, such that an alignment force may be improved. In the present exemplary embodiment, it has been described that after irradiation with the polarized ultraviolet rays of the first wavelength, irradiation with the polarized ultraviolet rays of the second wavelength occurs, but the present invention is not limited thereto. That is, the manufacturing method of the liquid crystal display according to exemplary embodiments of the present invention may comprise simultaneously irradiation with the polarized ultraviolet rays of the first wavelength and the polarized ultraviolet rays of the second wavelength.

Next, a cleaning process for removing the decomposed photo-alignment material may be performed.

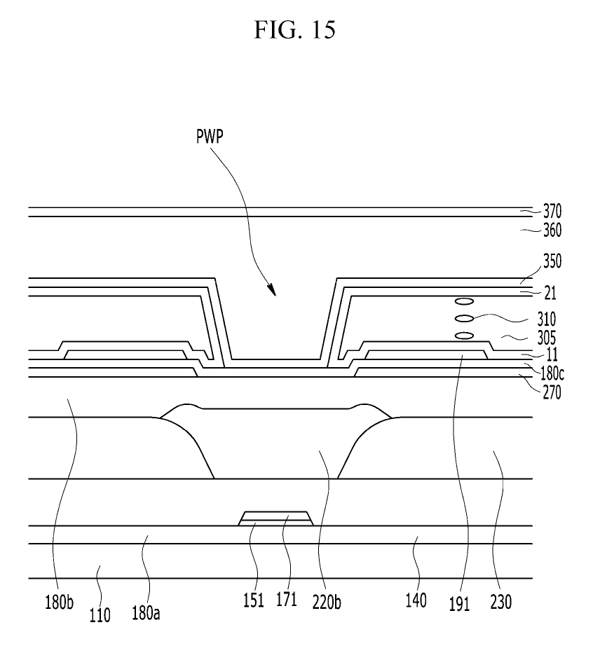

Referring to FIG. 15, the photo-alignment material alignment layers 11 and 21 are baked so that the alignment layers 11 and 21 may be formed along an inner wall of the microcavity 305 (S4).

Next, the liquid crystal material including the liquid crystal molecules 310 is injected into the microcavity 305 through the liquid crystal injection hole 307 using an Inkjet method and the like. The liquid crystal molecules 310 may be horizontally aligned.

Next, when the capping layer 390 is formed on the upper portion of the upper insulating layer 370 to cover the liquid crystal injection hole 307 and the liquid crystal injection hole forming region 307FP, the liquid crystal display may be formed as shown in FIG. 2.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 11, 21: alignment layer | 300: sacrificial layer |
| 305: microcavity | 307: liquid crystal injection hole |
| 310: liquid crystal molecules | 350: lower insulating layer |
| 360: roof layer | 370: upper insulating layer |
| 390: capping layer | |

What is claimed is:

1. A manufacturing method of a liquid crystal display, the method comprising:
forming a thin film transistor on a substrate;
forming a passivation layer on the thin film transistor;
forming a first electrode and a second electrode generating a horizontal electric field on the passivation layer;
forming a sacrificial layer on the second electrode;
forming a roof layer on the sacrificial layer;
removing the sacrificial layer to form a plurality of microcavities covered by the roof layer;
injecting a photo-alignment material into the plurality of microcavities;
irradiating the photo-alignment material with polarized light of a first wavelength and polarized light of a second wavelength;
baking the photo-alignment material; and
injecting a liquid crystal material into the plurality of microcavities.

2. The manufacturing method of the liquid crystal display of claim 1, wherein
the photo-alignment material comprises a photo-isomer material.

3. The manufacturing method of the liquid crystal display of claim 2, wherein
an alignment direction of the photo-alignment material is changed in the irradiating of the polarized light of the first wavelength.

4. The manufacturing method of the liquid crystal display of claim 3, wherein
the photo-alignment material comprises azo benzene.

5. The manufacturing method of the liquid crystal display of claim 4, wherein
the first wavelength is about 330 nanometers to about 380 nanometers.

6. The manufacturing method of the liquid crystal display of claim 5, wherein
the first wavelength is about 365 nanometers.

7. The manufacturing method of the liquid crystal display of claim 5, wherein
the polarized light of the first wavelength has energy of about 4 joules to about 6 joules.

8. The manufacturing method of the liquid crystal display of claim 3, wherein
the photo-alignment material is decomposed in the irradiating of the polarized light of the second wavelength.

9. The manufacturing method of the liquid crystal display of claim 8, wherein
the photo-alignment material comprises azo benzene.

10. The manufacturing method of the liquid crystal display of claim 9, wherein
the second wavelength is about 230 nanometers to about 270 nanometers.

11. The manufacturing method of the liquid crystal display of claim 10, wherein
the second wavelength is about 254 nanometers.

12. The manufacturing method of the liquid crystal display of claim 10, wherein
the polarized light of the second wavelength has energy of about 4 joules to about 6 joules.

13. The manufacturing method of the liquid crystal display of claim 1, comprising:
first irradiating the photo-alignment material with the polarized light of the first wavelength and then irradiating the photo-alignment material with the polarized light of the second wavelength.

14. The manufacturing method of the liquid crystal display of claim 1, comprising:
irradiating the photo-alignment material simultaneously with the polarized light of the first wavelength and the polarized light of the second wavelength.

15. A liquid crystal display comprising:
a substrate;
a thin film transistor disposed on the substrate;
a passivation layer disposed on the thin film transistor;
a first electrode and a second electrode disposed on the passivation layer and generating a horizontal electric field together;
an alignment layer disposed on the second electrode; and
a roof layer facing the second electrode,
wherein a plurality of microcavities are formed between the second electrode and the roof layer, each of the microcavities comprises a liquid crystal material, and
the alignment layer comprises a photo-alignment material that is decomposed when irradiated with light of a predetermined wavelength.

16. The liquid crystal display of claim 15, wherein
the photo-alignment material comprises a photo-isomer material.

17. The liquid crystal display of claim 16, wherein
the photo-alignment material comprises azo benzene.

18. The liquid crystal display of claim 17, wherein
an alignment direction of the photo-alignment material is changed by irradiating the photo-alignment material with light having a wavelength of about 330 nanometers to about 380 nanometers, and the photo-alignment material is decomposed by irradiating the photo-alignment material with light having a wavelength of about 230 nanometers to about 270 nanometers.

19. The liquid crystal display of claim 17, wherein
an alignment direction of the photo-alignment material is changed by irradiating the photo-alignment material with light having a wavelength of about 365 nanometers, and the photo-alignment material is decomposed by irradiating the photo-alignment material with light having a wavelength of about 254 nanometers.

20. The liquid crystal display of claim 16, further comprising:
a lower insulating layer disposed between the microcavities and the roof layer;
an upper insulating layer disposed on the roof layer; and
a capping layer disposed on the upper insulating layer.
